(19) United States
(12) Patent Application Publication
(10) Pub. No.: US 2025/0068706 A1
(43) Pub. Date: Feb. 27, 2025

(54) SYSTEM AND METHOD FOR AN IMAGE EXCHANGE WITH ORIGIN TRACING

(71) Applicant: Austin Thomas Johannes Visschedyk, West Palm Beach, FL (US)

(72) Inventor: Austin Thomas Johannes Visschedyk, West Palm Beach, FL (US)

(21) Appl. No.: 18/812,995

(22) Filed: Aug. 22, 2024

Related U.S. Application Data
(60) Provisional application No. 63/534,283, filed on Aug. 23, 2023.

(51) Int. Cl. G06F 21/16; G06F 21/10

(52) U.S. Cl. CPC G06F 21/16; G06F 21/1066

(57) ABSTRACT

The present invention is a system and method for high-bandwidth digital content protection, to be implemented on an array of platforms. The disclosed invention utilizes convolutional neural networks to scan a plurality of online databases, datasets, and content libraries to determine the authentication and origination of digital content and to prevent the appropriation of digital media and content. The present invention implements metadata preservation schemas and utilizes artificial intelligence to determine whether an image has been doctored or appropriated. In addition, the present invention provides a marketplace for brands and content creators to professionally interact and collaborate.

### CROSS REFERENCE TO RELATED APPLICATIONS

This application claims the benefit of U.S. Provisional Patent Application Ser. No. 63/534,283 filed on Aug. 23, 2023, the contents of which are incorporated herein by reference.

### BACKGROUND OF THE INVENTION

With the rise of social media applications and content creation platforms, the need to source pieces of media such as images and videos have become essential. Reverse image searching is one approach to finding the source of a particular piece of media, however, traditional applications dedicated to media sourcing do not always pinpoint the exact origin but rather every time the image has been distributed online. While this might be sufficient for the average internet browser, this can often lead to a myriad of problems for the content creators themselves-one being a loss of revenue due to the lack of engagement with their original content, and various copyright issues that may arise from their content being appropriated and commercialized without their permission. This is particularly helpful in certain professional environments, wherein a content creator's likeness or privacy may be violated and appropriated upon redistribution of their online content, and for digital creatives who are the forefront of social media trends.

The present invention, instead, seeks to remedy the issues that may arise from image sharing by creating a platform and data schema that discloses the origin of a piece of media and enables the creator to share said media on their own terms. Moreover, the present invention also provides a platform for image management, sourcing and browsing that highlight the portfolio of a content creator with verifiable sourcing and corresponding identifiers to describe their content, making it easier for brands and individuals who wish to buy or license their content without the middleman of a sourcing agency. The process disclosed generates more revenue for content creators, minimizes the fees companies accrue associated with seeking talent and organizing professional shoots, and creates incentives for the platform at a fraction of typical costs.

### SUMMARY OF THE INVENTION

The present invention relates to a system and method for image sharing, licensing, exchanging, and tracing. The community comprises of a content creator, who creates and distributes content, and spectators or buyers, who can either view and engage with content or seek to license or redistribute it with special permissions. The image platform accommodates both personal and professional environments.

Every image that is uploaded to the platform must be verified as belonging to the uploader. The metadata is used to confirm the time and date a photo is taken, and may in some embodiments, prompt recollection from an uploader. In addition to verifying the metadata of an image, the image is cross-referenced in a plurality of databases that are stored within a central secure server and receives APIs and image streams from various online web pages and sources. The machine algorithm employs a convolutional neural network, operating on a device connected to a central processing unit and graphical processing unit, in order to cross-reference a database of locally stored and cloud-stored memory stored images. In the example of non-transitory memory stored images, the images may be cross-referenced to other iterations of said image for the original, non-doctored image. If the image is redistributed and the content creator is the original owner based off the convolutional neural network scan, then the image may be published. If the image has no history of redistribution and is wholly the owner's, the image is also published. The image then generates a unique identification marker which can be any form of high-bandwidth digital content protection, by way of example and not limitation, metadata preservation schemas, digital certificates, non-fungible tokens and certificates, a blockchain ledger, and or a timed publication, which limits certain individuals or all individuals from attempting to screen capture a piece of media. It is important to note that the proprietary platform may operate on a centralized or decentralized network, wherein the blockchain platform operates peer-to-peer with nodes distributed across the network.

The proprietary platform utilizes and implements artificial intelligence in a myriad of ways. For example, artificial intelligence may be used to detect copyright infringement. Content based identification measures such as optical character recognition are implemented to analyze all images with text, and all submissions with text to cross-reference in databases and web archive; whereas natural language processing algorithms analyze bodies or portions of text. Word vector coding trains the A.I model for analysis and verification. These methods ensure that works that are not blatantly cut and pasted but rather screenshotted are not being stolen and redistributed without the proper licensing and consents and even prevent trademark infringement. In another embodiment, a visual warning may be generated if content is deemed misappropriated. Furthermore, content that is misappropriated can be reported, and automatically detected by the platform's A.I algorithm or manually assessed by intellectual property professionals.

The authentication process full transparency for potential collaborators who wish to license or purchase the rights to a particular image for commercial use. In addition, some sources for images may also include web archives to ensure the authenticity and origin of an image. Each authenticated image uploaded comes with a digital certificate that confirms the owner of the image. Advanced schemas, such as metadata preservation, may also be implemented in the present invention in order to avoid the redistribution of images and the illicit claiming of images.

In one incarnation, the platform offers a blockchain-based interface for creating non-fungible tokens for trade or sale. A user may take a photograph, create digital art, and generate a non-fungible token on the application interface. The application may enable trade by way of cryptographic tokens, traditional currency, or using non-fungible tokens similar in valuation.

In one embodiment of the present invention, a company may send out a request for content for a campaign. Then, content creators may respond with their available content and the company can place a bid or purchase it instantaneously based on said content creator's terms of agreement. The company may request additional services from the photographer or content creator, such as editing, reshoots, etc. or they may utilize their own team of creatives. Companies may also find creators using their tags, or specific search terms that are linked to their content.

In another embodiment of the present invention, the platform is able to determine whether or not an image has been doctored by cross-referencing all iterations of said image through unique identification markers and an image database. Moreover, an unedited image of a doctored image may be generated and presented to a user if their ownership of the image can be verified.

The platform and application may be implemented through a payment per use or on a subscription basis and may accommodate the content creator and their preferences.

### BRIEF DESCRIPTION OF THE DRAWINGS

The various embodiments are illustrated by way of example, and not by way of limitation, in the figures of the accompanying drawings. Having thus described the invention in general terms, reference will now be made to the accompanying drawings, which are not necessarily drawn to scale, and wherein:

FIG. 1 is a flow diagram of the process in which companies and brands may reach out to content creators or ‘broadcast’ a request for content for a campaign, or other brand-related need.

FIG. 2 is an example of the present invention's machine learning process, as implemented in a reverse image search verification.

FIG. 3 is an exemplary memory unit, which is utilized by a central processing unit and a graphics processing unit.

FIG. 4 is a content creator upload module for users and creators within the platform and software application.

FIG. 5 is a line diagram illustrating a distributed network.

FIG. 6 is a block diagram illustrating components of an exemplary operating environment in which embodiments of the present invention may be implemented,

FIG. 7 illustrates an exemplary computer system, in which embodiments of the present invention may be implemented.

FIG. 8 is a diagram of an example of a cloud storage organization in which web services accesses and retrieves user data as objects in buckets within a cloud storage space.

FIG. 9 is a diagram of the flow of access between the platform of the present invention and a web services client via cloud software tools.

FIG. 10 is an illustration of a multi-server room and the various locations in which other pertinent server rooms may exist.

FIG. 11 is a line diagram illustrating a distributed network.

### DETAILED DESCRIPTION OF THE PREFERRED EMBODIMENT

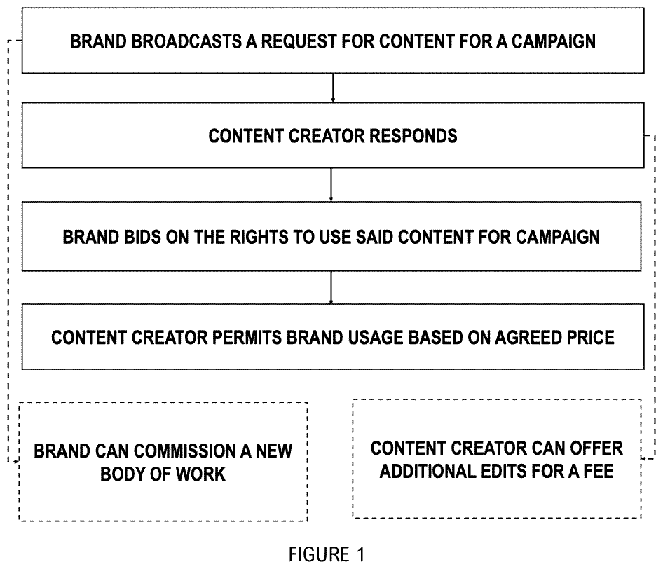

FIG. 1 is a flow diagram of the process in which companies and brands may reach out to content creators or ‘broadcast’ a request for content for a campaign, or other brand-related need. In accordance with the preferred embodiment of the present invention, content creators can respond to a request and brands, in turn, bid on the rights to use the content in a campaign. If the content creator permits, the brand can use the content on an agreed price—either by winning the bidding war or buying it at a price set by the content creator. Brands can also commission new bodies of work from a distinguished content creator, and a content creator may offer additional edits and creative services for another fee. In addition to verifying the metadata of an image, the image is cross-referenced in a plurality of databases that are stored within a central secure server and receives APIs and image streams from various online web pages and sources.

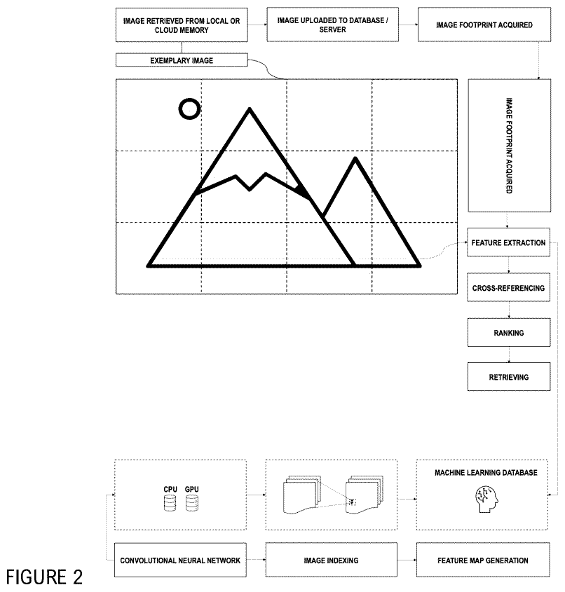

FIG. 2 is an example of the present invention's machine learning process, as implemented in a reverse image search or other related content-based identification format. In accordance with the preferred embodiment of the present invention, an image is retrieved from local or cloud memory on a processing device. The image is uploaded to a database and secure content server, the image footprint is acquired, alongside all metadata associated with the image. Then, machine learning algorithms are used to search an image database and web archive. Feature extraction, cross-referencing, ranking and retrieval are all methods used by the machine learning and artificial intelligence algorithm. Feature extraction operates on a convolutional neural network, which index images and generates feature maps. These feature maps are all then implemented into the network's machine learning database.

The machine algorithm employs a convolutional neural network, operating on a device connected to a central processing unit and graphical processing unit, in order to cross-reference a database of locally stored and cloud-stored memory stored images. In the example of non-transitory memory stored images, the images may be cross-referenced to other iterations of said image for the original, non-doctored image. If the image is redistributed and the content creator is the original owner based off the convolutional neural network scan, then the image may be published. If the image has no history of redistribution and is wholly the owner's, the image is also published. The image then generates a unique identification marker which can be any form of high-bandwidth digital content protection, by way of example and not limitation, metadata preservation schemas, digital certificates, non-fungible tokens and certificates, a blockchain ledger, and or a timed publication, which limits certain individuals or all individuals from attempting to screen capture a piece of media, or more generally preventing unwanted screen capture of a piece of media.

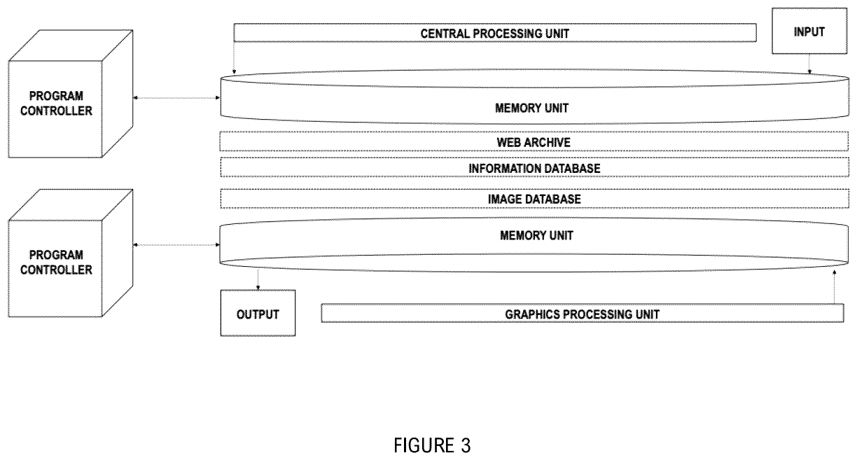

FIG. 3 is an exemplary memory unit, which is utilized by a central processing unit and a graphics processing unit. In accordance with the preferred embodiment of the present invention, the memory unit comprises of a web archive, information database and image database. The memory unit is also connected to a program controller which helps retrieve specific images based off a set of programmed controls through the application's software. An input is a piece of media whereas an output can be any cross-referenced piece of media acquired from the search.

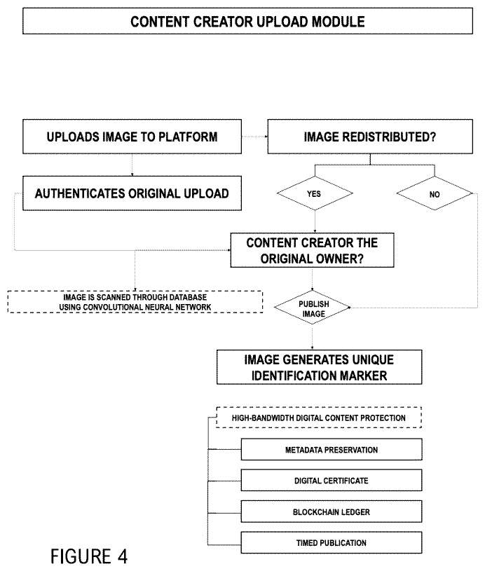

FIG. 4 is a content creator upload module for users and creators within the platform and software application. In accordance with the preferred embodiment of the present invention, a user uploads an image to a platform and the platform runs a search to see if the image has been redistributed on external webpages or within the platform itself. This is all a part of the image authentication process. If the image is redistributed and the content creator is the original owner based off the convolutional neural network scan, then the image may be published. If the image has no history of redistribution and is wholly the owner's, the image is also published. The image then generates a unique identification marker which can be any form of high-bandwidth digital content protection, by way of example and not limitation, metadata preservation schemas, digital certificates, non-fungible tokens and certificates, a blockchain ledger, and or a timed publication, which limits certain individuals or all individuals from attempting to screen capture a piece of media.

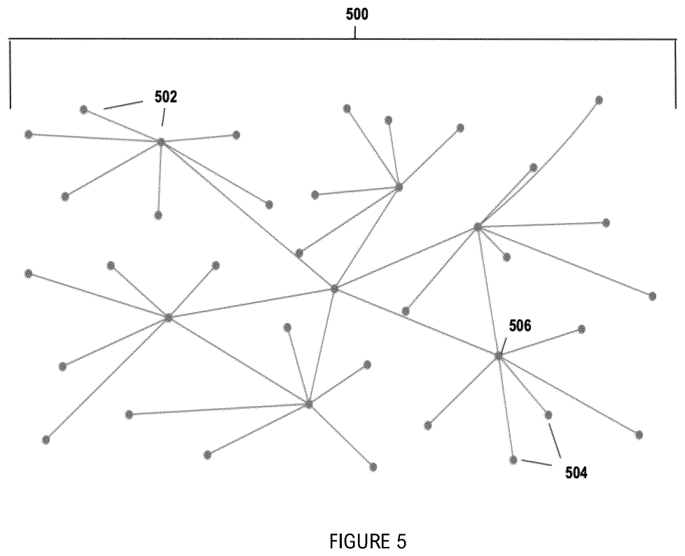

FIG. 5 is a line diagram illustrating a distributed network. For comparison purposes, FIG. 5, which is generally represented by the numeral 500, illustrates a distributed network. Specifically, the illustration shows the interconnection of each node 502 in a distributed decentralized network 500. In accordance with the preferred embodiment of the present invention, each node 502 in the distributed network 500 is directly connected to at least two other nodes 504. This allows each node 502 to transact with at least one other node 502 in the network. The present invention can be deployed on a centralized, decentralized, or distributed network.

In one embodiment, each transaction (or a block of transactions) is incorporated, confirmed, verified, included, or otherwise validated into the blockchain via a consensus protocol. Consensus is a dynamic method of reaching agreement regarding any transaction that occurs in a decentralized system. In one embodiment, a distributed hierarchical registry is provided for device discovery and communication. The distributed hierarchical registry comprises a plurality of registry groups at a first level of the hierarchical registry, each registry group comprising a plurality of registry servers. The plurality of registry servers in a registry group provides services comprising receiving client update information from client devices and responding to client lookup requests from client devices. The plurality of registry servers in each of the plurality of registry groups provide the services using, at least in part, a quorum consensus protocol.

As another example, a method is provided for device discovery and communication using a distributed hierarchical registry. The method comprises Broadcasting a request to identify a registry server, receiving a response from a registry server, and sending client update information to the registry server. The registry server is part of a registry group of the distributed hierarchical registry, and the registry group comprises a plurality of registry servers. The registry server updates other registry servers of the registry group with the client update information using, at least in part, a quorum consensus protocol.

The present invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents.

Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

The units described above can be implemented as software components executing on one or more general purpose processors, as hardware such as programmable logic devices and/or Application Specific Integrated Circuits designed to perform certain functions or a combination thereof. In some embodiments, the units can be embodied by a form of software products which can be stored in a nonvolatile storage medium (such as optical disk, flash storage device, mobile hard disk, etc.), including several instructions for making a computer device (such as personal computers, servers, network equipment, etc.) implement the methods described in the embodiments of the present invention. The units may be implemented on a single device or distributed across multiple devices. The functions of the units may be merged into one another or further split into multiple sub-units.

The methods or algorithmic steps described in light of the embodiments disclosed herein can be implemented using hardware, processor-executed software modules, or combinations of both. Software modules can be installed in random-access memory (RAM), memory, read-only memory (ROM), electrically programmable ROM, electrically erasable programmable ROM, registers, hard drives, removable disks, CD-ROM, or any other forms of storage media known in the technical field.

Persons of ordinary skill in the art are able to understand that all or portions of the steps in the embodiments described above may be realized using programs instructing the relevant hardware and said programs can be stored on computer-readable storage media, such as a read-only memory, hard disk or compact disc. Optionally, all or portions of the steps of the embodiments described above may also be realized using one or multiple integrated circuits. Accordingly, the various modules/units contained in the embodiments above may also be realized in the form of hardware or software function modules. Thus, the present application is not limited to any specific combination of hardware and software.

The present application may have a variety of other embodiments and, without departing from the spirit and substance of the present application, persons skilled in the art may produce a variety of corresponding changes and modifications based on the present application, but these corresponding changes and modifications shall all fall within the scope of protection of the claims of this application.

Although the foregoing embodiments have been described in some detail for purposes of clarity of understanding, the invention is not limited to the details provided. There are many alternative ways of implementing the invention. The disclosed embodiments are illustrative and not restrictive.

While the invention has been described in detail and with reference to specific embodiments thereof, it will be apparent to those skilled in the art that various changes and modifications can be made therein without departing from the spirit and scope thereof. Thus, it is intended that the present invention cover the modifications and variations of this invention provided they come within the scope of the appended claims and their equivalents.

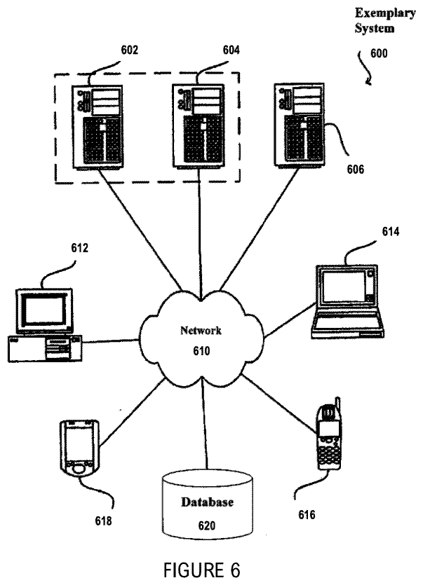

FIG. 6 is a block diagram illustrating components of an exemplary operating environment in which embodiments of the present invention may be implemented. In accordance with the preferred embodiment of the present invention, the system 600 can include one or more user computers, computing devices, or processing devices 612, 614, 616, 618, which can be used to operate a client, such as a dedicated application, web browser, etc. The user computers 612, 614, 616, 618 can be general purpose personal computers (including, merely by way of example, personal computers and/or laptop computers running a standard operating system), cell phones or PDAs (running mobile software and being Internet, e-mail, SMS, Blackberry, or other communication protocol enabled), and/or workstation computers running any of a variety of commercially-available UNIX or UNIX-like operating systems (including without limitation, the variety of GNU/Linux operating systems). These user computers 612, 614, 616, 618 may also have any of a variety of applications, including one or more development systems, database client and/or server applications, and Web browser applications. Alternatively, the user computers 612, 614, 616, 618 may be any other electronic device, such as a thin-client computer, Internet-enabled gaming system, and/or personal messaging device, capable of communicating via a network (e.g., the network 610 described below) and/or displaying and navigating Web pages or other types of electronic documents. Although the exemplary system 600 is shown with four user computers, any number of user computers may be supported.

In most embodiments, the system 600 includes some type of network 610. The network can be any type of network familiar to those skilled in the art that can support data communications using any of a variety of commercially available protocols, including without limitation TCP/IP, SNA, IPX, AppleTalk, and the like. Merely by way of example, the network 610 can be a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, GRPS, GSM, UMTS, EDGE, 2G, 2.5G, 3G, 4G, Wimax, WiFi, CDMA 2000, WCDMA, the Bluetooth protocol known in the art, and/or any other wireless protocol); and/or any combination of these and/or other networks.

The system may also include one or more server computers 602, 604, 606 which can be general purpose computers, specialized server computers (including, merely by way of example, PC servers, UNIX servers, mid-range servers, mainframe computers rack-mounted servers, etc.), server farms, server clusters, or any other appropriate arrangement and/or combination. One or more of the servers (e.g., 606) may be dedicated to running applications, such as a business application, a Web server, application server, etc. Such servers may be used to process requests from user computers 612, 614, 616, 618. The applications can also include any number of applications for controlling access to resources of the servers 602, 604, 606.

The Web server can be running an operating system including any of those discussed above, as well as any commercially-available server operating systems. The Web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 612, 614, 616, 618. As one example, a server may execute one or more Web applications. The Web application may be implemented as one or more scripts or programs written in any programming language, such as Java®, C, C# or C++, and/or any scripting language, such as Perl, Python, or TCL, as well as combinations of any programming/scripting languages. The server(s) may also include database servers, including without limitation those commercially available from Oracle®, Microsoft®, Sybase®, IBM® and the like, which can process requests from database clients running on a user computer 612, 614, 616, 618.

The system 600 may also include one or more databases 620. The database(s) 620 may reside in a variety of locations. By way of example, a database 620 may reside on a storage medium local to (and/or resident in) one or more of the computers 602, 604, 606, 612, 614, 616, 618. Alternatively, it may be remote from any or all of the computers 602, 604, 606, 612, 614, 616, 618, and/or in communication (e.g., via the network 610) with one or more of these. In a particular set of embodiments, the database 620 may reside in a storage-area network (“SAN”) familiar to those skilled in the art. Similarly, any necessary files for performing the functions attributed to the computers 602, 604, 606, 612, 614, 616, 618 may be stored locally on the respective computer and/or remotely, as appropriate. In one set of embodiments, the database 620 may be a relational database, such as Oracle 10g, that is adapted to store, update, and retrieve data in response to SQL-formatted commands.

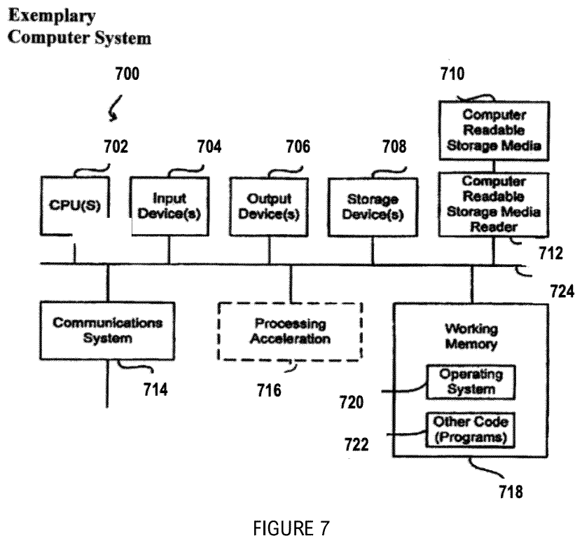

FIG. 7 illustrates an exemplary computer system 700, in which embodiments of the present invention may be implemented. The system 700 may be used to implement any of the computer systems described above. The computer system 700 is shown comprising hardware elements that may be electrically coupled via a bus 724. The hardware elements may include one or more central processing units (CPUs) 702, one or more input devices 704 (e.g., a mouse, a keyboard, etc.), and one or more output devices 706 (e.g., a display device, a printer, etc.). The computer system 700 may also include one or more storage devices 708. By way of example, the storage device(s) 708 can include devices such as disk drives, optical storage devices, solid-state storage device such as a random-access memory (“RAM”) and/or a read-only memory (“ROM”), which can be programmable, flash-updateable and/or the like.

The computer system 700 may additionally include a computer-readable storage media reader 712, a communications system 714 (e.g., a modem, a network card (wireless or wired), an infra-red communication device, etc.), and working memory 718, which may include RAM and ROM devices as described above. In some embodiments, the computer system 700 may also include a processing acceleration unit 716, which can include a digital signal processor DSP, a special-purpose processor, and/or the like.

The computer-readable storage media reader 712 can further be connected to a computer-readable storage medium 710, together (and, optionally, in combination with storage device(s) 708) comprehensively representing remote, local, fixed, and/or removable storage devices plus storage media for temporarily and/or more permanently containing, storing, transmitting, and retrieving computer-readable information. The communications system 714 may permit data to be exchanged with the network and/or any other computer described above with respect to the system 700.

The computer system 700 may also comprise software elements, shown as being currently located within a working memory 718, including an operating system 720 and/or other code 722, such as an application program (which may be a client application, Web browser, mid-tier application, RDBMS, etc.). It should be appreciated that alternate embodiments of a computer system 700 may have numerous variations from that described above. For example, customized hardware might also be used and/or elements might be implemented in hardware, software (including portable software, such as applets), or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, data signals, data transmissions, or any other medium which can be used to store or transmit the desired information and which can be accessed by the computer. Based on the disclosure and teachings provided herein, a person of ordinary skill in the art will appreciate other ways and/or methods to implement the various embodiments.

As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

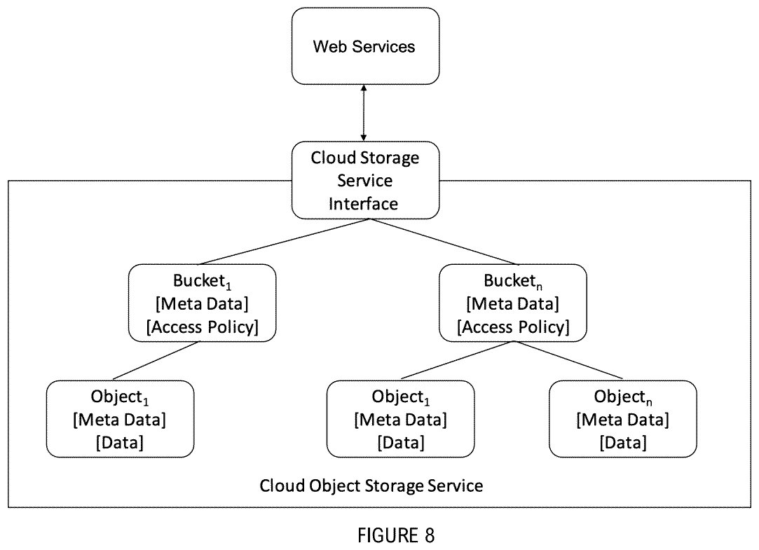

FIG. 8 is a diagram of an example of a cloud storage organization in which a web services accesses and retrieves user data as objects in buckets within a cloud storage space. In accordance with the preferred embodiment of the present invention, the cloud storage service is a means of storing and protecting any amount of data for a range of use cases. A bucket is a container for objects stored in the cloud storage service, and objects consist of object data and metadata. The metadata is a set of name-value pairs that describe the object. These pairs include some default metadata, such as the date last modified, and standard HTTP metadata, such as Content-Type. You can also specify custom metadata at the time that the object is stored. Web services provide access to and from the cloud object storage service via the cloud storage service interface.

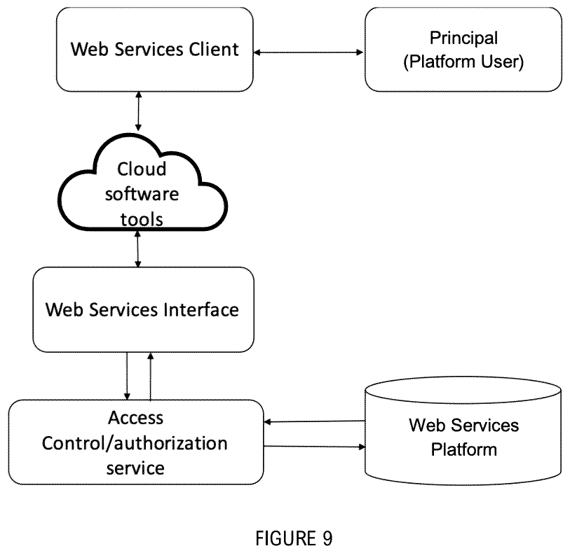

FIG. 9 is a diagram of the flow of access between the platform of the present invention and the web services client via cloud software tools. In accordance with the preferred embodiment of the present invention, the principal or platform user accesses the web services client, which then transmits data via cloud software tools to the web services interface. Access control and authorization acts as a layer in order to access the web services platform by way of the web services interface.

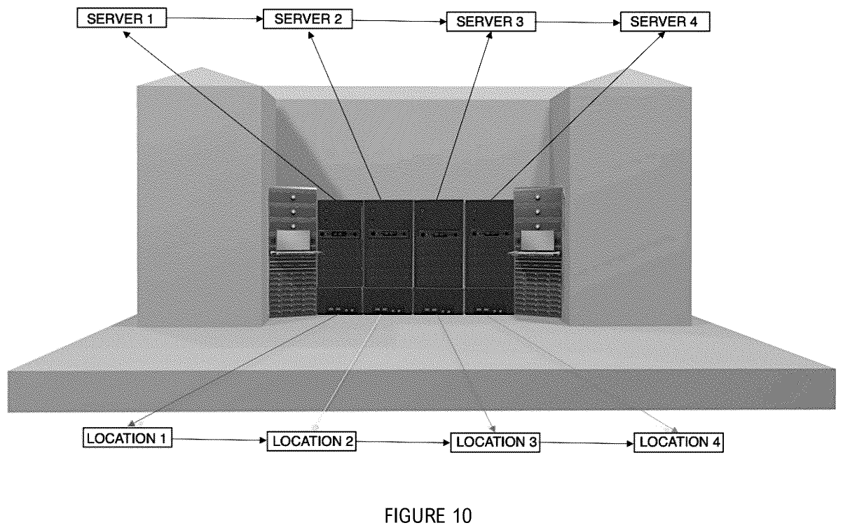

FIG. 10 is an illustration of server-to-server connections, within a server room and to other sever room locations. In accordance with the preferred embodiment of the present invention, the web server undergoes an initialization process and features a database of wireless network data. Dependent on the service requested, the data may undergo processing. The servers actively attempt to retrieve the appropriate data to provide user input. Data may then be formatted, and with the appropriate authorizations, saved or restructured.

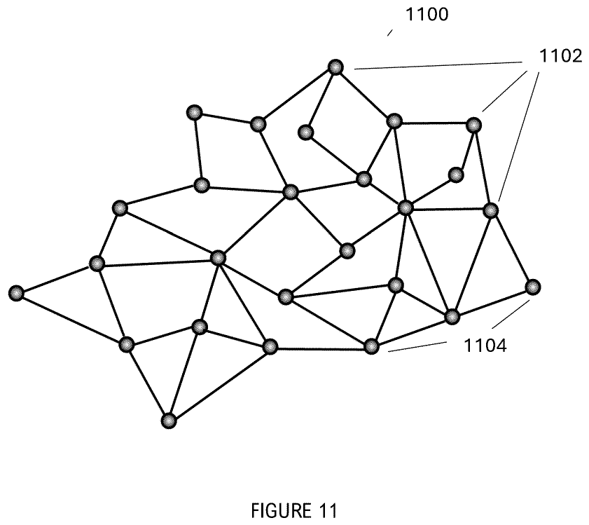

FIG. 11 is a line diagram illustrating a distributed network. For comparison purposes, FIG. 11, which is generally represented by the numeral 1100, illustrates a distributed network. Specifically, the illustration shows the interconnection of each node 1102 in a distributed decentralized network 1100. In accordance with the preferred embodiment of the present invention, each node 1102 in the distributed network 1100 is directly connected to at least two other nodes 1104. This allows each node 1102 to transact with at least one other node 1102 in the network. The present invention can be deployed on a centralized, decentralized, or distributed network.

In one embodiment, each transaction (or a block of transactions) is incorporated, confirmed, verified, included, or otherwise validated into the blockchain via a consensus protocol. Consensus is a dynamic method of reaching agreement regarding any transaction that occurs in a decentralized system. In one embodiment, a distributed hierarchical registry is provided for device discovery and communication. The distributed hierarchical registry comprises a plurality of registry groups at a first level of the hierarchical registry, each registry group comprising a plurality of registry servers. The plurality of registry servers in a registry group provide services comprising receiving client update information from client devices, and responding to client lookup requests from client devices. The plurality of registry servers in each of the plurality of registry groups provide the services using, at least in part, a quorum consensus protocol.

As another example, a method is provided for device discovery and communication using a distributed hierarchical registry. The method comprises broadcasting a request to identify a registry server, receiving a response from a registry server, and sending client update information to the registry server. The registry server is part of a registry group of the distributed hierarchical registry, and the registry group comprises a plurality of registry servers. The registry server updates other registry servers of the registry group with the client update information using, at least in part, a quorum consensus protocol.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the technology disclosed herein. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

What is claimed is:

1. A system for image exchange with origin tracing, said system comprising:
a memory unit comprising:
a web archive;
an information database; and
an image database;
a network;
a program controller connected to said memory unit and configured to retrieve specific images based on a set of programmed controls via an application's software;
at least one processor in communication with said memory unit, wherein said memory unit contains computer-readable instructions, which when executed by said processor, cause said system to:
confirm, via metadata of an input, a time and date of said input;
cross-reference said input in a plurality of databases;
employ, via a machine algorithm, a convolutional neural network configured to cross-reference a database of locally stored and cloud-stored memory-stored images;
determine, via said convolutional neural network, a redistribution history of said input;
publish an output;
generate a unique identification marker.

2. The system of claim 1, wherein said input is a piece of media.

3. The system of claim 1, wherein said input is an image.

4. The system of claim 1, wherein said output is a cross-referenced piece of media acquired from a search based on said input.

5. The system of claim 1, wherein said system prompts a user to input a date and time of an input.

6. The system of claim 1, wherein said plurality of databases are stored within a central secure server.

7. The system of claim 1, wherein said convolution neural network operates on a device connected to a central processing unit and a graphical processing unit.

8. The system of claim 1, wherein said unique identification marker is configured to prevent unwanted screen capture of said output.

9. A method for image exchange with origin tracing, said method comprising:
receiving, via a platform associated with a software application located on a central processing unit, an input from a user;
prompting said user to provide information relevant to said input;
confirming, via metadata of said input, a time and date of said input;
cross-referencing, via said software application, said input in a plurality of databases;
employing, via a machine algorithm associated with said software application, a convolutional neural network configured to cross-reference a database of locally stored and cloud-stored memory-stored images;
determining, via said convolutional neural network operating on a device connected to said central processing unit and a graphical processing unit, a redistribution history of said input;
publishing, via said software application, an output;
generating, via said software application, a unique identification marker configured to prevent unwanted screen capturing of said output.

10. The method of claim 9, wherein said input is a piece of media.

11. The method of claim 9, wherein said input is an image.

12. The method of claim 9, wherein said output is a cross-referenced piece of media acquired from a search based on said input.

13. The method of claim 9, wherein said plurality of databases are stored within a central secure server.

14. The method of claim 9, wherein said convolution neural network operates on a device connected to a central processing unit and a graphical processing unit.

15. The method of claim 9, wherein said plurality of databases are stored within a central secure server.

16. A system for image exchange with origin tracing, said system comprising:
a memory unit comprising:
a web archive;
an information database; and
an image database;
a network;
a program controller connected to said memory unit and configured to retrieve specific images based on a set of programmed controls via an application's software;
at least one central processing unit in communication with said memory unit, wherein said memory unit contains computer-readable instructions, which when executed by said central processing unit, cause said system to:
receive, via a platform associated with a software application located on said central processing unit, an input from a user;
confirm, via metadata of an input, a time and date of said input;
cross-reference said input in a plurality of databases stored within a central secure server;
employ, via a machine algorithm, a convolutional neural network operating on a device connected to said central processing unit and a graphical processing unit configured to cross-reference a database of locally stored and cloud-stored memory-stored images;
determine, via said convolutional neural network, a redistribution history of said input;
publish an output;
generate a unique identification marker configured to prevent unwanted screen capture of said output.

17. The system of claim 16, wherein said input is a piece of media.

18. The system of claim 16, wherein said input is an image.

19. The system of claim 16, wherein said output is a cross-referenced piece of media acquired from a search based on said input.

20. The system of claim 16, wherein said system prompts a user to input a date and time of an input.
